(19) United States
(12) Patent Application Publication
(10) Pub. No.: US 2020/0102788 A1
(43) Pub. Date: Apr. 2, 2020

(54) STAIRCASE WITH FOLDABLE TREADS

(71) Applicant: MORryde International, Inc., Elkhart, IN (US)

(72) Inventors: Jason Anthony Byers, Topeka, IN (US); Raymond Lambright, Topeka, IN (US)

(73) Assignee: MORryde International, Inc., Elkhart, IN (US)

(21) Appl. No.: 16/589,804

(22) Filed: Oct. 1, 2019

Related U.S. Application Data
(60) Provisional application No. 62/739,913, filed on Oct. 2, 2018.

(51) Int. Cl. E06C 1/387

(52) U.S. Cl. CPC E06C 1/387; B60R 3/02

(57) ABSTRACT

A folding staircase having a pair of stringers and at least one tread spanning between the stringers. Each of the stringers having an upper end and a lower end. Each of the treads having a forward edge and a rearward edge that define the width of each tread. The treads being pivotally moveable between the stringers. A linkage connecting each tread at a pivot point. The treads being movable between a use position and a stowed position.

This application claims the benefit of U.S. Provisional Application No. 62/739,913, filed Oct. 2, 2018, the disclosures of which are hereby incorporated by reference.

### BACKGROUND

Folding staircases are commonly used for recreational vehicles (“RV”) to easily enter and leave the RV. Sometimes the staircase is contained within the vehicle and this is often done when the staircase is relatively small. However, this approach lacks flexibility in that the staircase cannot be used at any location other than that chosen by the RV manufacturer and limits the storage location of the staircase to only that one position chosen by the vehicle manufacturer. In cases where the user may want to have a larger staircase or one with more treads, presently available staircases offer little flexibility. Many times, complicated linkages are involved in the folding staircases that add weight and size, thereby limiting the available storage locations. A simple staircase that folds down to be as small as possible and allows flexibility as to how it is stored is needed.

### BRIEF DESCRIPTION OF THE DRAWINGS

FIG. 1 is a perspective view of the staircase with the treads and linkage bars in their stowed position;

FIG. 2 is a magnified view of the staircase in FIG. 1;

FIG. 3 is a perspective view of the staircase in FIGS. 1-2 with the treads and linkage bars in an intermediate position rotated from the stowed position;

FIG. 4 is a magnified view of the staircase in FIG. 3;

FIG. 5 is a perspective view of the staircase in FIGS. 1-4 with the treads and linkage bars in their use position;

FIG. 6 is a magnified view of the staircase in FIG. 5;

FIG. 7 is a perspective view of the staircase shown in FIGS. 1-6 with the treads and linkage bars in their use position shown from above;

FIG. 8 is a rear view of the staircase shown in FIGS. 1-7;

FIG. 9 is a magnified view of the upper end of a stringer that shows details of the attachment housing;

FIG. 10 shows the underside of the attachment housing shown in FIG. 9; and

FIG. 11 shows the locking saddle outside of the attachment housing viewing the locking wall and opening therein.

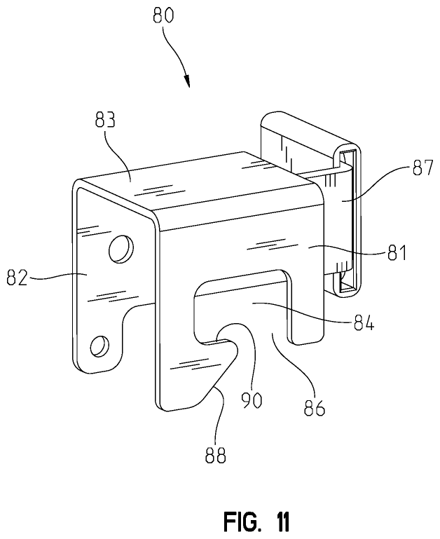

### SUMMARY OF THE INVENTION

A folding staircase having a pair of stringers with each having an upper edge and a lower edge. The distance between the upper edge and lower edge defining a height of the stringers. Each of the stringers having an upper end and a lower end. At least one tread being located between the stringers. Each of the treads having a forward edge and a rearward edge that define the width of each tread. The treads being pivotally connected between the upper end lower edges of the stringers. A linkage connecting each of the treads at pivot points. The treads being movable between a use position and a stowed position.

### DETAILED DESCRIPTION OF THE INVENTION

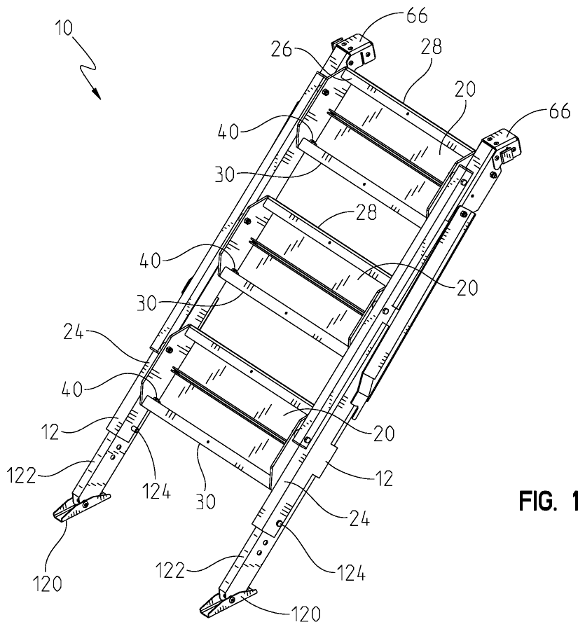

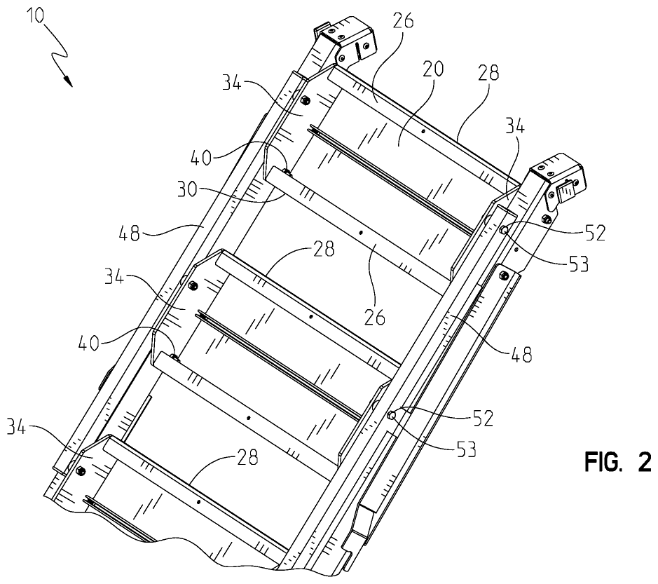

The staircase 10 of the present invention has a pair of stringers 12 that each have an upper edge 14 and a lower edge 16 that defines a height of the stringers 12. The stringers 12 have inner sides 13 and outer sides 15. The upper and lower edges 14, 16 are generally planar surfaces that span across the stringers 12. The stringers 12 have upper ends 17 and lower ends 18. The upper ends 17 of the stringers 12 are for being attached to a structure (not shown) to which the staircase 10 will be used to enter. The lower ends 18 of the stringers 12 are for contacting a ground surface adjacent to the structure. Treads 20 are located between the stringers 12. The treads 20 are extrusions that have an upper surface 24 that is generally planar and a lower surface 26 that is formed by portions of the extrusion that curl under the upper surface 24. As shown in FIG. 1, the lower surface 26 is formed by the lowermost portions of the extrusion that makes the treads 20 but does not extend completely across the bottom of the treads 20. It is contemplated that the treads 20 may be formed of a rectangular tubular extrusion, and in that case the lower surface 26 would be continuous across the width of the treads 20. The distance between the upper surface 24 and the lower surface 26 defines the thickness of the tread 20. Each tread has a forward edge that faces the side of the staircase 10 that will be climbed by a user and rearward edge 30 that is on the opposite side of the tread 20 and faces the structure to which the staircase 10 will be used to enter. The distance between the forward edge 28 and rearward edge 30 defines the width of each tread 20. The ends of the treads 20 are capped by end plates 34 at their lateral ends. The end plates 34 may be attached to their corresponding treads 20 by self-tapping screws 38 that are driven into portions of the tread 20. The end plates 34 extend beyond the thickness of their corresponding treads 20 as can be seen in FIG. 2. The end plates 34 extend in a direction beyond the lower surface 26 of the treads 20.

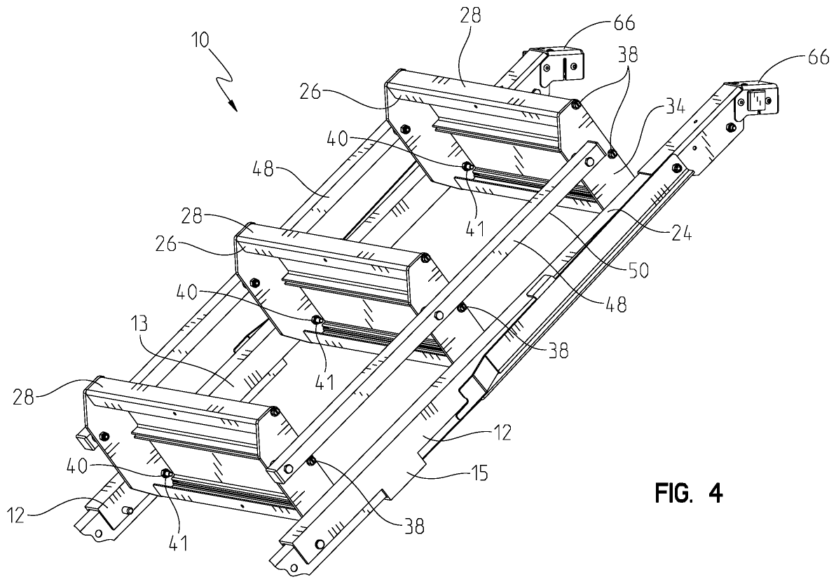

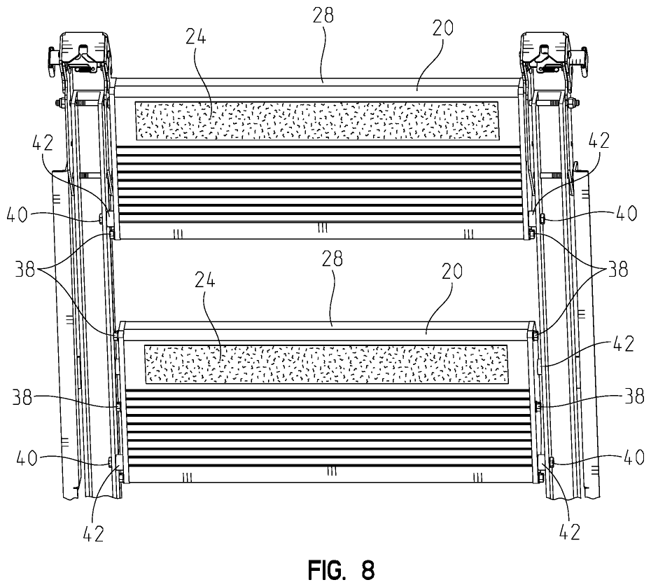

Each tread 20 is pivotally mounted between the stringers 12 between their inner sides 13. Each tread 20 pivots with respect to the stringers 12 about bolts 40 driven through the end plates 34. The bolts 40 form a first pivot point 41 through the centers of the bolts 40. Bolts 40 are best seen in FIGS. 1 and 4. The first pivot point 41 is located immediately adjacent to the rearward edges 30 of the treads 20. The end plates 34 are spaced slightly from the inner sides 13 of the stringers 12 by spacers 42 surrounding each bolt 40. The spacers are typically a low friction plastic that facilitates smooth pivoting about the bolts 40. The spacers 42 provide a gap between the inner sides 13 of the stringers 12 and the end plates 34. The gap allows the self-tapping screws 38 to pass between the stringers 12 without striking the inner sides 13. It is also possible to allow the treads 20 to be located between the stringers 12 without spacers 42 if countersunk self-tapping screws are used to mount the end plates 34 to the treads 20. Using countersunk screws would eliminate the protrusion of the heads the self-tapping screws 38 beyond the end plates 34, thus, allowing the end plates 34 to be closely aligned with the inner sides 13 of the stringers 12. Self-tapping screws 38 as shown in FIG. 8 require spacers 42 so that the heads of the screws 38 do not rub the inner sides of the stringers 12.

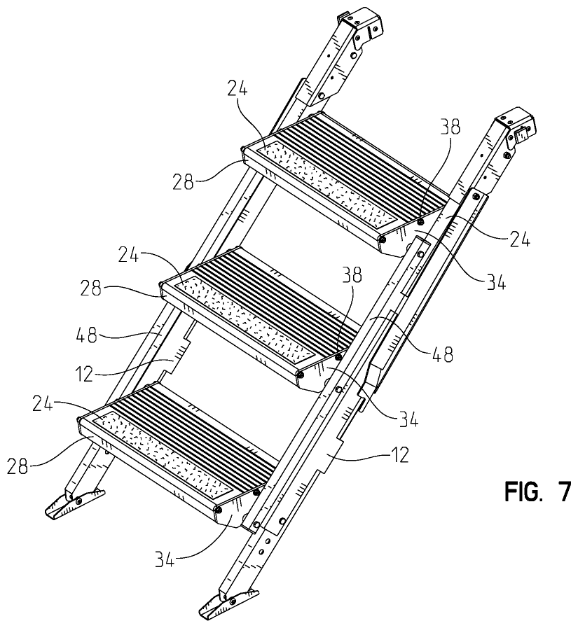

In the staircase 10 three treads 20 are shown. The number of treads 20 could be more than three if necessary to traverse a desired height for which the staircase 10 will be used. Each tread 20 is straddled by linkage bars 48. The linkage bars 48 are hollow square tubes, but could be flat or solid bar stock as well. The linkage bars 48 being square tubes provides a rigid light weight linkage that can be use to push or pull. The linkage bars 48 have a lower surface 50 that faces the upper surfaces 24 of the stringers 12. Each tread 20 has bolts 52 that are driven through an adjacent linkage bar 48 and a corresponding end plate 34. As shown in FIGS. 1-7, there are linkage bars 48 on both sides of the treads 20, however, it is possible to use only one linkage bar 48 on one side of the treads 20. Having a pair of linkage bars 48 provides a more stable structure and prevents jamming and having a pair of linkage bars 48 is preferable. Bolts 52 include spacers 42 that facilitate smooth movement of the linkages as the treads 20 pivot with respect to the stringers 12. The centers of the bolts 52 that are driven through the linkage bars 48 and end plates 34 of the treads 20 form a second pivot 53 point that is spaced from the first pivot point on the end plates 34 so that the second pivot point 53 is spaced outwardly from the upper edges 14 of the stringers 12 in all of the positions where the treads 20 may be located.

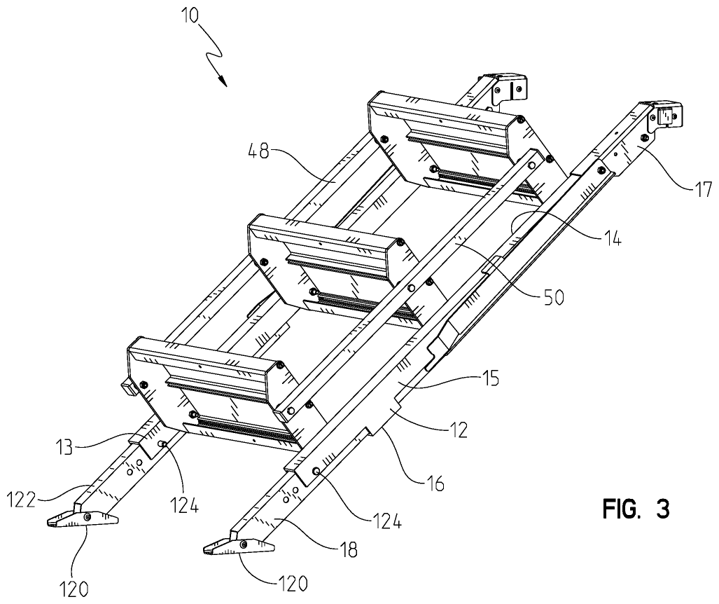

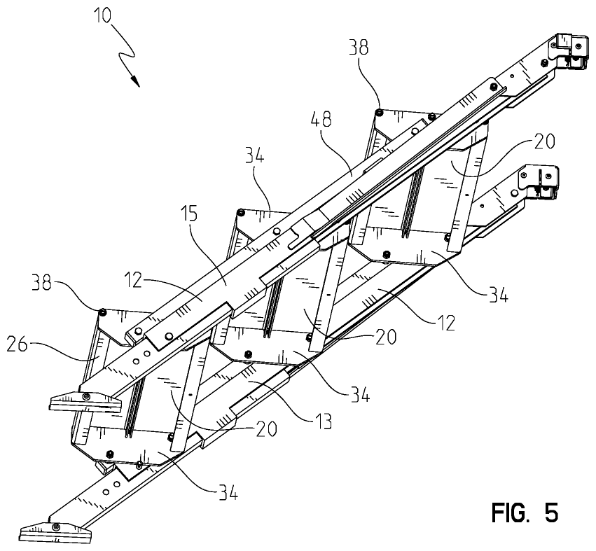

The treads 20 and linkage bars 48 are pivotable between a stowed position and a use position. FIGS. 1 and 2 show the treads 20 and linkage bars 48 in the stowed position; FIGS. 5-7 show the treads 20 and linkage bars 48 in the use position; and FIGS. 3 and 4 show the treads 20 and linkage bars 48 in an intermediate position to the stowed and use positions. The stowed position is characterized by the treads 20 being located entirely between the stringers 12 and the lower surfaces 50 of the linkage bars 48 contacting the upper edges 14 of the stringers 12. Although the treads 20 are located entirely between the stringers 12, with no portion of said treads 20 extending beyond said upper and lower edges 14, 16 of said stringers, the end plates 34 have a portion that extends beyond the upper edges 14 of the stringers. The portion of the end plates 34 that extends beyond the upper edges 14 of the stringers 12 provides a location for the second pivot point 53 that is outside of the stringers 12. In the stowed position, the treads 20 take up minimal space because no parts of the treads 20 extend beyond the stringers 12. In other words, no part of the treads 20 extend beyond the upper and lower edges 14, 16 of the stringers 12 when in the stowed position and this provides an extremely low profile for the staircase 10 that enables to be easily stored. As shown in FIG. 2, the end plates 34 do not extend beyond the linkage bars 48 in the stowed position, which also helps provide an extremely low profile for the staircase 10 when the treads 20 are in the stowed position. The upper surfaces 24 of the treads 20 in the stowed position are located entirely between the stringers 12 and the upper surfaces 24 face away from the upper edges 14 of the stringers 12. Due to the positioning of the second pivot point 53 relative to the first pivot point 41 the entirety of each tread 20 is located outside of the linkage bars 48 in the stowed position so that no portion of the treads 20 are located between the linkage bars 48 in the stowed position. The contact the linkage bars 48 make with the upper edges 14 of the stringers 12 prevents further rotation of the treads 20 that would put portions of the treads 20 beyond the lower edges 16 of the stringers 12. When the treads 20 are in their stowed position, the linkage bars 48 contact the stringers 12 at a relatively far distance from the lower ends 18 of the stringers. In this manner, the linkage bars 48 provide a lock from further rotation of the treads 20 in a clockwise direction as viewed in FIG. 2. Linkage bars 48 act as the only restraint from further rotation when they impinge on the stringers 12 as shown in FIGS. 1 and 2. The stowed position is further characterized by the linkage bars 48 being located relatively high on the stringers 12 or in other words, the linkage bars 48 are relatively near the upper ends 17 of the stringers 12.

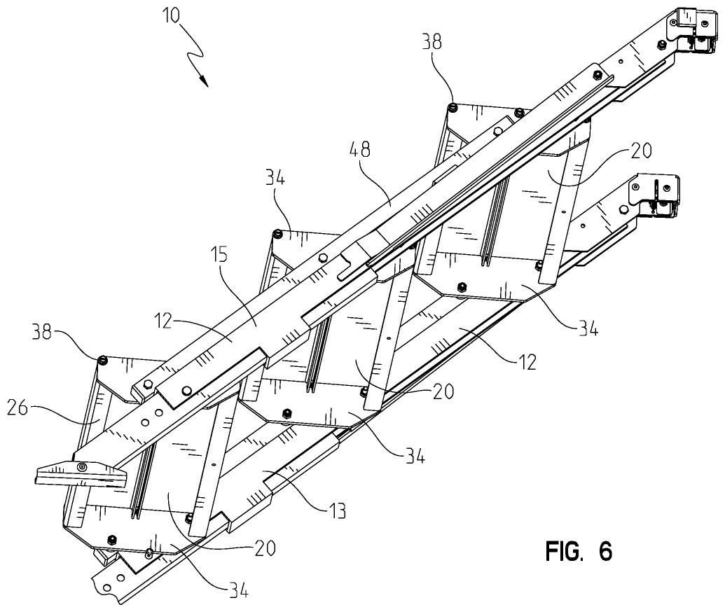

As the treads 20 are rotated counterclockwise from their stowed position, the treads 20 and linkage bars 48 reach an intermediate position shown in FIGS. 3 and 4. As the treads 20 rotate, the treads 20 move from behind the linkage bars 48 so that the treads 20 cross the linkage bars 48 and are located between the linkage bars. In the intermediate position, the linkage bars 48 are parallel to the upper edges 14 of the stringers 12 and the linkage bars 48 are at their maximum distance from the stringers 12. From the intermediate position, the treads 20 can be rotated further in the counterclockwise direction so that the linkage bars 48 again come to impinge upon the upper edges 14 of the stringers 12, as shown in FIGS. 5 and 6. In the use position shown in FIGS. 5 and 6, the linkage bars 48 impinge on the upper edges 14 of the stringers 12 to prevent further rotation of the treads 20 in a counterclockwise direction. In this use position, the linkage bars 48 are relatively far from the upper ends 17 of the stringers 12 and relatively near the lower ends 18 of the stringers 12 when compared to the stowed position. The treads 20 extend beyond the linkage bars 48 so that, in the use position, each linkage bar 48 is located at a position intermediate to the forward edges 28 and rearward edges 30 of the treads 20. During movement from the stowed position to the use position, the treads 20 move from a position behind and completely outside of the linkage bars 48 to a position between the linkage bars 48. Because the entire length of each linkage bar 48 contacts the stringers 12 directly, the configuration shown in FIGS. 5-7 provides an extremely strong and light weight structure that simultaneously locks all of the treads 20 from rotation in the counterclockwise direction. As such, when the treads 20 bear weight, which will be spaced away from the first pivot point 41, the linkage bars 48 prevent the counterclockwise rotation that the weight spaced from the first pivot point will impart. Further, any weight placed on the treads 20 will be evenly distributed through the linkage bars 48, which allows the use of lighter materials than would otherwise be possible. No other locking mechanism than the linkage bars 48 are needed to maintain the treads 20 in their use position when weight is placed upon them. In the use position, the treads 20 remain cantilevered beyond and extending across the linkage bars 48 and have no obstructions near the forward edge 28 of each tread 20. The treads 20 extend beyond the stringers 12 for most of their length in the use position. The same linkage 48 that synchronizes the movement of the treads 20 is the same mechanism that provides the locking function though the impingement of their lower surfaces 50 on the stringers 12.

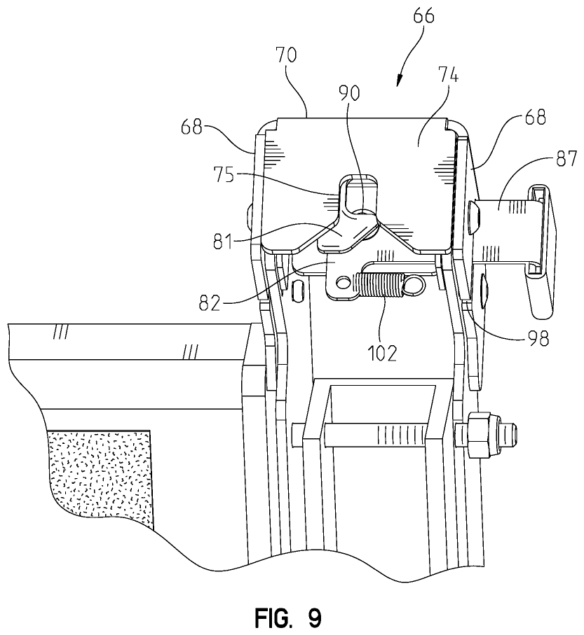

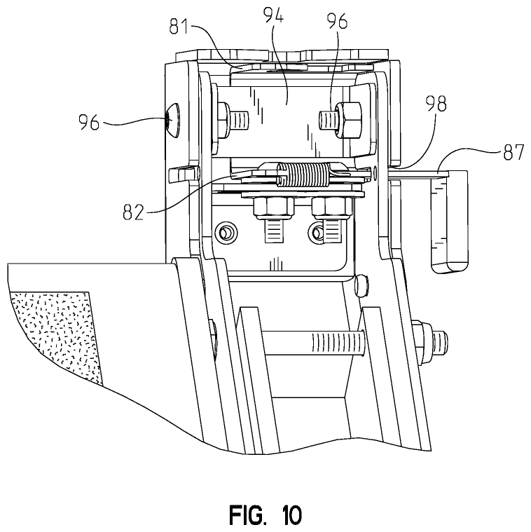

The upper ends 17 of the stringers 12 have an attachment housing 66 that is for connecting to the structure on which the staircase 10 will be used. FIG. 10 shows the underside of the attachment housing 66. The attachment housing 66 has sides 68 that are affixed to the stringers 12 and a top wall 70 that spans between the sides 68. The top wall 70 is joined to a receiver plate 74 that has a funnel shaped opening 75 for receiving a rivet, bolt, kingpin, or similar fastener (not shown) that is attached to the vehicle. FIG. 9 shows the receiver plate 74 as it faces the fastener to which it will connect. Generally, the fastener that is located on the vehicle or structure connected to the staircase and the fastener will have a shank and a head that is larger than the shank. The attachment housing 66 holds a locking saddle 80 that slides with respect to the top wall 70 of the housing and the receiver plate 74. The locking saddle 80 has a locking wall 81 and a back wall 82 that are joined by a top wall 83. The locking and back walls 81, 82 are substantially parallel to each other and the top wall 83 is perpendicular to the locking and back walls 81, 82. The locking wall 81 of the locking saddle 80 has an aperture 84 that has an opening 86 that opens in the same direction as the opening 75 in the receiver plate 74. Adjacent to the opening 86 is an inclined edge 88 that is adjacent to an undercut edge 90 that is within the opening 86. The back wall 82 has a push tab 87 that extends outwardly therefrom.

The locking saddle 80 is held slidably in within the attachment housing 66 with a mounting bracket 94 that his held in the attachment housing 66 with bolts 96. The locking saddle 80 is held between the mounting bracket 94 and the top wall 70 of the attachment housing. As can be seen in FIG. 9, the push tab 87 extends from one side 68 of the attachment housing 66 through slot 98. The locking saddle 80 is shiftable between a locked position shown in FIG. 9 that locates the inclined edge 88 within the opening 75 of the receiver plate 74, and an unlocked position that locates the opening 86 of the locking wall 81 in aligned position with the opening 75 of the receiver plate 74. A spring 102 connected to the back wall 82 of the locking saddle 80 and a side 68 of the attachment housing 66 and biases the locking saddle 80 toward the locked position within the attachment housing 66. In the locked position, the undercut edge 90 within the opening 86 is aligned with the opening 75 in the receiver plate 74, and thereby blocks the opening 75. Thus, the locking wall 81 and the receiver plate 74 cooperate to capture a fastener that is located within the openings 75, 86. The fastener on the vehicle is configured so that its shank diameter fits within the receiver plate 74 opening 75 and the opening 86 in the locking saddle 80. When the shank of the fastener strikes the inclined edge 88, the locking saddle 80 is urged toward its unlocked position so that the fastener may be received within both openings 75 and 86. Once the shank of the fastener passes the inclined edge 88, the locking saddle 80 will shift to its locked position and the undercut edge 90 cooperates with the opening 75 in the receiver plate 74 to form a smaller aperture than the head of the fastener. Thus, the fastener remains captured in the attachment housing 66 and prevents the staircase 10 from being pulled off of the fastener to which it is connected.

The lower ends of the stringers 12 have pivotal feet 120 that are pivotally connected to telescoping legs 122 that are tubes telescopingly received within the stringers 12. The telescoping legs 122 have locking pins 124 that may be used to selectively lock the legs 122 with respect to the stringers.

When a user wishes to use the staircase 10, the treads 20 and linkage bars 48 will begin in their stowed position, in which the staircase 10 may be stored in a relatively small space due to the treads 20 being located entirely between the stringers 12. The user will locate the staircase 10 adjacent to the vehicle or structure to which the staircase 10 will be attached and adjust the feet 120 as necessary. Then, the user will attach the attachment housing 66 to fasteners extending from the structure to which the staircase 10 will be attached and slide the staircase 10 downwardly so the fastener enters the opening 75 in the receiving plate 74. As the shank of the fastener enters the receiving plate 74 it pushes the locking saddle 80 to the unlocked position until the fastener passes the inclined edge 88, and the locking saddle 80 will be returned to the locked position because the spring 102 will bias it in that direction. The user may then rotate any tread 20 into its use position and the remaining treads 20 will rotate into the use position.

What is claimed is:

1. A folding staircase comprising:
a pair of stringers, each of said stringers including an upper edge and a lower edge defining a height of said stringers and said stringers having a lower end and an upper end;
a plurality of treads located between said stringers, said treads having a forward edge and a rearward edge defining a width of each said tread, each said tread having an upper surface, each of said treads pivotally connected to said stringers at a first pivot point, said first pivot point located between said upper and lower edges of said stringers;
a linkage pivotally connecting each of said treads at second pivot points, said second pivot points connected to said treads at a location farther from said rearward edge than said first pivot point and said second pivot point located outside of said stringers, said linkage having a lower surface;
said linkage and said treads movable between a stowed position and a use position, said stowed position defined by said lower surface of said linkage contacting said upper edge of said stringer at a position relatively far from said lower end of said stringer and restraining said treads from further rotation of said treads in one direction and permitting rotation of said treads in another direction, said upper surface of said treads being located between said upper and said lower edges of said stringers in said stowed position, said use position having said treads rotated in said another direction from said stowed position and having said lower surface of said linkage contacting said upper edge of said stringer relatively near said lower end of said stringer and restraining said treads from further rotation in said another direction.

2. The folding staircase of claim 1, wherein said treads are straddled by a pair of linkages pivotally connected to each said tread.

3. The folding staircase of claim 2, wherein said treads include a lower surface spaced from said upper surface and each said tread including end plates being located between said tread and said stringers at lateral ends of said tread; said second pivot point being located on said end plates spaced from said lower surface of said treads.

4. The folding staircase of claim 3, wherein said upper end of said stringers includes an attachment housing including a receiver plate for receiving a fastener in a slot, a locking wall located behind said receiver plate, said locking wall being shiftable between a locked and unlocked position and said locking wall blocking said slot in said receiver plate in said locked position.

5. A folding staircase comprising:
a pair of stringers, each of said stringers including an upper edge and a lower edge defining a height of said stringers, said stringers having a lower end and an upper end;
a plurality of treads located between said stringers, said treads having an upper surface and a lower surface, each of said treads pivotally connected to said stringers at a first pivot point, said first pivot point located between said upper and lower edges of said stringers and said first pivot point located on each said tread between said upper and lower surfaces;
a linkage pivotally connecting each of said treads at second pivot points, said linkage having a lower surface;
said linkage and said treads movable between a stowed position and a use position, said stowed position defined by said linkage contacting said stringer restraining said treads from further rotation of said treads in one direction and permitting rotation of said treads in another direction, said use position having said treads rotated in said another direction from said stowed position and having said linkage contacting said stringer and restraining said treads from further rotation in said another direction, said use position of said linkage locating said linkage at a location shifted from where said linkage contacts said stringer in said stowed position.

6. The folding staircase of claim 5, wherein said tread is located entirely between said stringers in said stowed position with no portion of said tread extending beyond said upper and lower edges of said stringers.

7. The folding staircase of claim 5, wherein said treads include a lower surface spaced from said upper surface and each said tread including end plates being located between said tread and said stringers at lateral ends of said tread; said second pivot point being located on said end plates spaced from said treads.

8. The folding staircase of claim 5, said upper end of said stringers includes an attachment housing including a receiver plate for receiving a fastener in a slot, a locking wall located behind said receiver plate, said locking wall being shiftable between a locked and unlocked position and said locking wall blocking said slot in said receiver plate in said locked position.

9. The folding staircase of claim 5, wherein said treads are straddled by a pair of linkages pivotally connected to each said tread.

10. A folding staircase comprising:
a pair of stringers, each of said stringers including an upper edge and a lower edge defining a height of said stringers, said stringers having a lower end and an upper end;
a plurality of treads located between said stringers, said treads having a forward edge, a rearward edge, an upper surface and a lower surface, each of said treads pivotally connected to said stringers at a first pivot point, said first pivot point located between said upper and lower edges of said stringers and said first pivot point located on each tread between said upper and lower surfaces;
a linkage pivotally connecting each of said treads at second pivot points, said linkage having a lower surface;
said linkage and said treads movable between a stowed position and a use position, said stowed position defined by said linkage contacting said stringer restraining said treads from further rotation of said treads in one direction and permitting rotation of said treads in another direction, said use position having said treads rotated in said another direction from said stowed position and having said linkage contacting said stringer and restraining said treads from further rotation in said another direction, said use position of said linkage locating said linkage at a location spaced from where said linkage contacts said stringer in said stowed position, movement of said treads from said stowed position to said use position causing said treads to be moved from a location beyond said linkage and between the stringers to a cantilevered position intersecting said linkage and having said forward edge extending beyond said linkage opposite said stringers.

11. The folding staircase of claim 10, said upper end of said stringers includes an attachment housing including a receiver plate for receiving a fastener in a slot, a locking wall located behind said receiver plate, said locking wall being shiftable between a locked and unlocked position and said locking wall blocking said slot in said receiver plate in said locked position.

12. The folding staircase of claim 10, wherein said treads are straddled by a pair of linkages pivotally connected to each said tread.

13. The folding staircase of claim 10, wherein said treads are straddled by said linkage and a second linkage and movement of said treads from said stowed position to said use position causing said treads to be moved from a location beyond said linkages and between said stringers to a cantilevered position between said linkages and having said forward edge extending beyond said linkages opposite said stringers.
